(19) United States
(12) Patent Application Publication
(10) Pub. No.: US 2013/0066838 A1
(43) Pub. Date: Mar. 14, 2013

(54) EFFICIENT DATA RECOVERY

(71) Applicants: Amit Singla, Redmond, WA (US); Arasu Shankher Jeyaprakash, Chennai (IN); Bikash Kumar Agrawala, Hyderabad (IN); Deepanjyoti Sarkar, Hyderabad (IN); Pankaj Vasant Khanzode, Hyderabad (IN); Abhinav Srivastava, Hyderabad (IN); Vanita Prabhu, Hyderabad (IN)

(72) Inventors: Amit Singla, Redmond, WA (US); Arasu Shankher Jeyaprakash, Chennai (IN); Bikash Kumar Agrawala, Hyderabad (IN); Deepanjyoti Sarkar, Hyderabad (IN); Pankaj Vasant Khanzode, Hyderabad (IN); Abhinav Srivastava, Hyderabad (IN); Vanita Prabhu, Hyderabad (IN)

(73) Assignee: Microsoft Corporation, Redmond, WA (US)

(21) Appl. No.: 13/230,794

(22) Filed: Sep. 12, 2011

(51) Int. Cl. G06F 17/30

(52) U.S. Cl. 707/679; 707/674; 707/E17.005

(57) ABSTRACT

Embodiments are directed to locating and restoring backed up items using a custom schema and to efficiently transferring recovery data. In an embodiment, a computer system defines a schema that provides data search and retrieval among backup data sets. The schema stores searchable attributes for each database item and leverages a file system to store file system metadata for the data items of the backup sets. The computer system receives a request to find data items among the backup data sets and accesses the schema to determine, from the stored searchable attributes, which recovery points among the backup data sets include the requested data items. The computer system also restores the requested data items from the determined recovery point within the backup data sets.

### BACKGROUND

Computers have become highly integrated in the workforce, in the home, in mobile devices, and many other places. Computers can process massive amounts of information quickly and efficiently. Software applications designed to run on computer systems allow users to perform a wide variety of functions including business applications, schoolwork, entertainment and more. Software applications are often designed to perform specific tasks, such as word processor applications for drafting documents, or email programs for sending, receiving and organizing email.

As such, software applications and their corresponding user-generated data are often very valuable to users and businesses. In many cases, this application data is backed up on other (remote) computer systems. Data backups typically store copies of each data file. As changes are made to these files over time, the backups overwrite the previously-stored backup data to ensure that the backed-up data is up-to-date. These data backups can become increasingly larger as time goes on and more and more users create and edit data. Processing and transferring these large amounts of data can become burdensome.

### BRIEF SUMMARY

Embodiments described herein are directed to locating and restoring backed up items using a custom schema and to efficiently transferring recovery data. In one embodiment, a computer system defines a schema that provides data search and retrieval among backup data sets. The schema stores searchable attributes for each database item and leverages a file system to store file system metadata for the data items of the backup sets. The computer system receives a request to find data items among the backup data sets and accesses the schema to determine, from the stored searchable attributes, which recovery points among the backup data sets include the requested data items. The computer system also restores the requested data items from the determined recovery point within the backup data sets.

In another embodiment, a computer system receives from a user an indication of various backup data items which are to be recovered from a specified recovery point in a set of data backups. The computer system computes checksum data corresponding to each of the user-specified backup data items and compares the computed checksum data of the user-specified backup data files to checksum data associated with data items already on the user's computer system to determine which segments of the backup data items are to be restored to the user. The computer system also receives from the data backups those backed up data items for which a checksum did not already exist on the user's computer system, and combines the received backup data items with the user's existing data items to fully recover the user's data.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

To further clarify the above and other advantages and features of embodiments of the present invention, a more particular description of embodiments of the present invention will be rendered by reference to the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a computer architecture in which embodiments of the present invention may operate including locating and restoring backed up items using a custom schema.

FIG. 2 illustrates a flowchart of an example method for locating and restoring backed up items using a custom schema.

FIG. 3 illustrates a flowchart of an example method for efficiently transferring recovery data.

FIG. 4 illustrates an alternative computer architecture embodiment in recovery data is efficiently transferred from a backup location to a recovery target.

### DETAILED DESCRIPTION

Embodiments described herein are directed to locating and restoring backed up items using a custom schema and to efficiently transferring recovery data. In one embodiment, a computer system defines a schema that provides data search and retrieval among backup data sets. The schema stores searchable attributes for each database item and leverages a file system to store file system metadata for the data items of the backup sets. The computer system receives a request to find data items among the backup data sets and accesses the schema to determine, from the stored searchable attributes, which recovery points among the backup data sets include the requested data items. The computer system also restores the requested data items from the determined recovery point within the backup data sets.

In another embodiment, a computer system receives from a user an indication of various backup data items which are to be recovered from a specified recovery point in a set of data backups. The computer system computes checksum data corresponding to each of the user-specified backup data items and compares the computed checksum data of the user-specified backup data files to checksum data associated with data items already on the user's computer system to determine which segments of the backup data items are to be restored to the user. The computer system also receives from the data backups those backed up data items for which a checksum did not already exist on the user's computer system, and combines the received backup data items with the user's existing data items to fully recover the user's data.

The following discussion now refers to a number of methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions in the form of data are computer storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM, solid state drives (SSDs) that are based on RAM, Flash memory, phase-change memory (PCM), or other types of memory, or other optical disk storage, magnetic disk storage or other magnetic storage devices, or any other medium which can be used to store desired program code means in the form of computer-executable instructions, data or data structures and which can be accessed by a general purpose or special purpose computer.

A “network” is defined as one or more data links and/or data switches that enable the transport of electronic data between computer systems and/or modules and/or other electronic devices. When information is transferred or provided over a network (either hardwired, wireless, or a combination of hardwired or wireless) to a computer, the computer properly views the connection as a transmission medium. Transmissions media can include a network which can be used to carry data or desired program code means in the form of computer-executable instructions or in the form of data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”), and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems that are linked (either by hardwired data links, wireless data links, or by a combination of hardwired and wireless data links) through a network, each perform tasks (e.g. cloud computing, cloud services and the like). In a distributed system environment, program modules may be located in both local and remote memory storage devices.

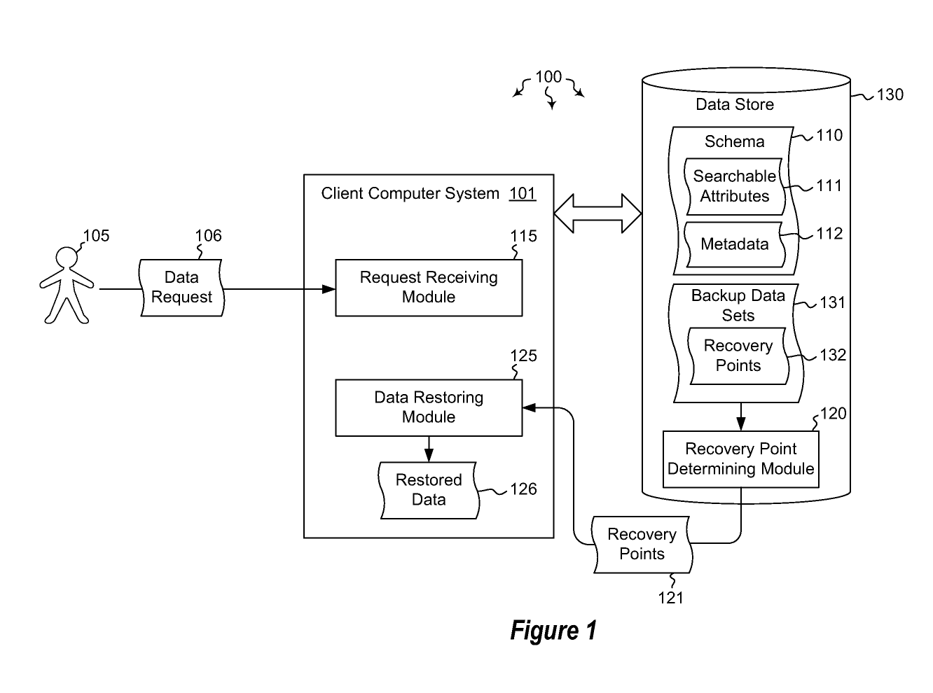

FIG. 1 illustrates a computer architecture 100 in which the principles of the present invention may be employed. Computer architecture 100 includes client computer system 101 as well as data store 130. These computer systems may be local or distributed computer systems and may include or use cloud computing systems. The computer systems may be configured to communicate with other computer systems and/or other devices. The computer systems may include various modules for performing specific tasks. These modules will be discussed in connection with various methods and systems below.

As indicated above, computer system users may create backups of their data. The backups typically include an operating system, one or more applications and various user-generated files and settings. Some embodiments described herein include a highly optimized catalog scheme to enable efficient search for items across backup sets and extraction of data items' metadata from specific backup sets. Embodiments also describe an efficient algorithm that uses existing data on or close to the recovery target (the computer system to which data is to be restored) to minimize the data transfer from backup storage (e.g. backup data sets 131 in data store 130).

The item level catalog may be split into 2 parts: one that stores the searchable attributes of the items (like name, last modified time, size, author etc) in a set of database tables, and another that stores file system metadata for the physical files that are part of the backup set. The first part provides efficient browse and search features for the recovery items. The second part helps with efficient storage during backup and extraction of metadata for physical files at the time of recovery. Both of these parts are described in more detail below.

In some cases, items stored in an item attribute catalog are hierarchical in nature. That is, the items have parent-child relationships. The items that represent a parent (e.g. directory, subdirectory, etc.) may be stored in a ParentItem table while the children are stored in a ChildItem table. Since each parent item can have multiple children, the information about the parent is not repeated and is stored only once.

In some embodiments, a particular item may appear in multiple versions. For example, a file “document.txt” under the c:\files directory would get backed up as part of a dated backup (e.g. Backup B1, B2, etc.). The file may continue to stay until backup B100. Then, when a user tries to browse files under c:\files for backup B50 to do recovery, the file document.txt appears in the list. In order to achieve this behavior, each item in the ParentItem and ChildItem table has a StartTime and EndTime. The StartTime indicates the first time when the item appeared and the EndTime indicates the time when the item became invalid (e.g. was deleted). This ensures that the entry for each item is not repeated in each version and, hence, the space used to store the information inside the table is minimal. This schema also helps in keeping the table as thin possible, which in turn helps in better query performance. The schema can efficiently expose a browse view where the cumulative list of all items in a time range can be seen thus avoiding the need for the user to go to each backup set and browse separately.

In some cases, extended information about child items may be stored in an additional table. The additional table uses a schema that is specific to the type of attributes stored and queried for. As such, the extended information allows for search and recovery functions that implement the extended information. For instance, software collaboration programs may list document-level properties and other list-level details in a specialized recovery search UI. Additionally or alternatively, for data files, the extended information may include modified time, changed time, file size and any other file system attributes. These may also be presented in a search or recovery user interface. Moreover, child item information may be extended to add specific child item properties based on the context of the child item's data source.

The path information that is stored in the ParentItem table can be as big as 32K characters or even longer in some embodiments. This information is split into two parts with the first part containing the first (e.g. 400) characters of the file path and the remaining goes into the second part. In most cases, the length of the item path is less than 400 characters. This mechanism helps in including the first part as part of the index which helps in faster query response. For the remainder of cases where the path is greater than 400 characters long, there also by having the first 400 characters part of the index, the query is narrowed down only to those very few rows with the first 400 characters matching the query.

The file metadata catalog may be maintained as a dataless virtual hard disk (VHD). A dataless VHD is one where files are created with all the metadata and attributes but no data streams are written for any file. Using a dataless VHD allows the file system itself to be used as the catalog format for file metadata. During recovery, this dataless VHD can be mounted and use file system's restore APIs to extract the metadata for the files to be recovered. This is more efficient than other formats for file metadata which convert the file system metadata to another (custom) format. These custom formats need to be changed each time a new feature is introduced in the file system. Using a dataless VHD allows the system to use the same file system version on the dataless VHD as the source and avoid dealing with any compatibility issues with custom formats.

To optimize data transfer during recover, an algorithm may be provided which is designed to function whether the source data is wholly or partially available. The algorithm may be applied in various different scenarios including the following: 1) a user needs to obtain an older version of the source data, 2) a user needs to revert to a state before data corruption, 3) a user needs to resume recovery after a failure or cancellation, and 4) a user needs to recover the backed up data to a recovery target over a low bandwidth and/or high latency connection.

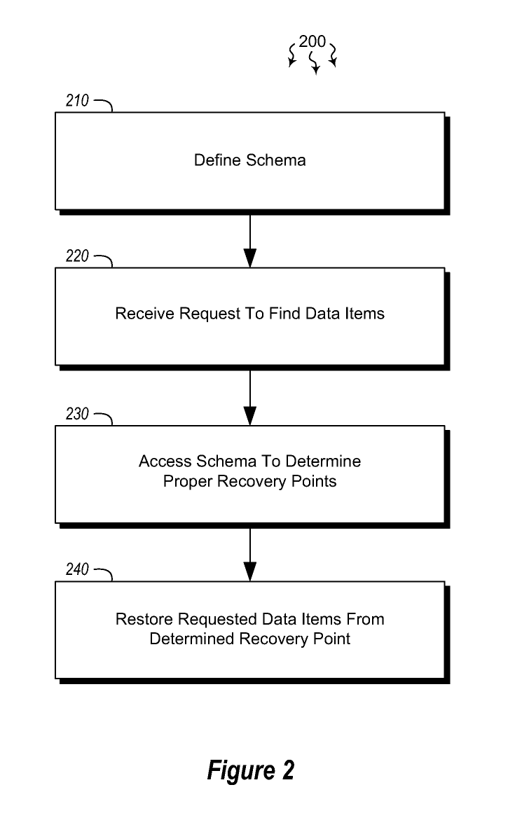

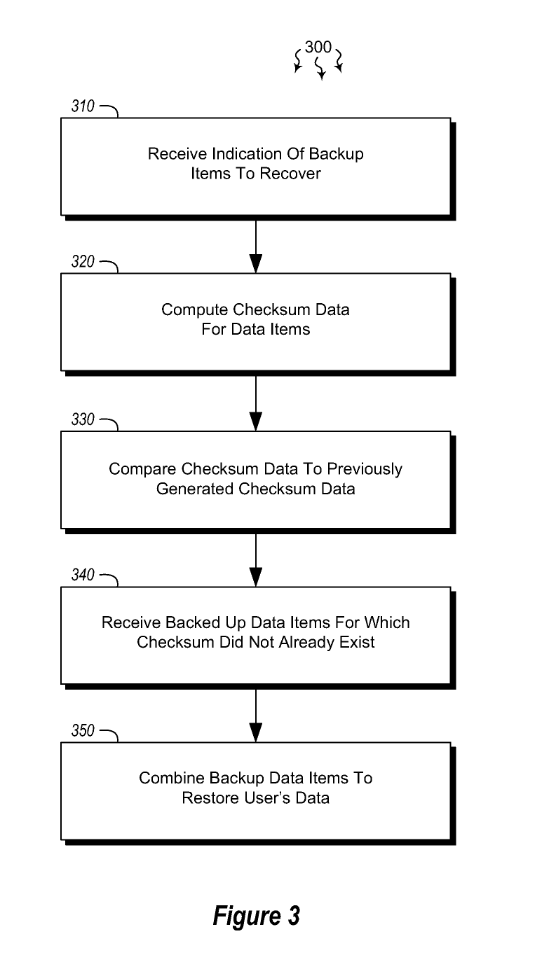

Rather than downloading all of the user's files in full, the data transfer is optimized by recovering only those parts of the source data that mismatch with the backup data. Checksum values are computed for the data in the backup set as well as for the data already available on the recovery target. Recovery is optimized by downloading only the data which doesn't have a data block with same checksum already available on recovery target. This algorithm may also be applied for recovering the data to alternate locations as well. The recovery program can intelligently copy the matching data blocks from the original location (if the checksum matches) and use the backup data only for the blocks that don't have any block with matching checksum in original location. These concepts will be explained in greater detail below with reference to methods 200 and 300 of FIGS. 2 and 3, respectively.

In view of the systems and architectures described above, methodologies that may be implemented in accordance with the disclosed subject matter will be better appreciated with reference to the flow charts of FIGS. 2 and 3. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 2 illustrates a flowchart of a method 200 for locating and restoring backed up items using a custom schema. The method 200 will now be described with frequent reference to the components and data of environment 100 of FIG. 1.

Method 200 includes an act of defining a schema configured to provide data search and retrieval among backup data sets, wherein the schema stores searchable attributes for each database item and leverages a file system to store file system metadata for the data items of the backup sets (act 210). For example, custom schema 110 may be defined by a user 105 or set of users. The schema may be designed to provide data search and retrieval for backup data sets 131. The schema itself includes various searchable attributes 111 for each database item (e.g. a file or set of files). The schema can use a local file system on computer system 101 to store file system metadata 112 for the data items of the different backup sets.

The searchable attributes may include indication of the time the data portion was first stored (i.e. the first recovery point) in the backup set. The searchable attributes may further include the time the data portion was last accessed (or when the data item was deleted) (i.e. the last recovery point). A user interface may be used which accesses the schema to display a span of backup sets any given data item is part of Thus, a user may specify in the user interface a data item, and the user interface may display a list or span of backup data sets of which the item is a part.

The file system metadata 112 may include parent information and file name information. The parent information may include drive and path information, including directories and subdirectories. In some embodiments, the parent information may be split into different files for data paths greater than 400 characters. The path that is thus split into two parts, the first of the two parts being limited in length to a predefined data length. This length may be 400 characters, or substantially any other number of characters. The parent information is only stored once for all files stored under the parent. Avoiding data path redundancies increases efficiency. The parent information and file name information may be stored in separate tables.

In some cases, the file system metadata 112 is stored in a dataless virtual hard drive. As explained above, the dataless virtual hard drive is configured to store data files created with their corresponding metadata and attributes, but without storing the actual data file's data. During data recovery, the dataless virtual hard drive is mounted and file system application programming interfaces (APIs) may be implemented to extract the metadata for the data items that are to be recovered (from backup data sets 131).

Returning to FIG. 2, method 200 includes an act of receiving a request to find one or more data items among at least one of the backup data sets (act 220). For example, request receiving module 115 may receive data request 106 from user 105 requesting that certain specified data items are to be found among the backed up data sets 131. The schema 110 may be accessed by the recovery point determining module so it can determine, from the stored searchable attributes 111, which recovery points 132 among the backup data sets include the requested data items (act 230). For example, if a file was included in backups B25-B50, and backup B50 included the latest version of the file, the recovery point determining module would send recover points B25-B50 to the data restoring module 125, which would then restore the requested data items 126 from the determined recovery point(s) within the backup data sets (act 240). As such, the schema 110 allows a minimal amount of data to be stored, and allows specific backed up items to be searched and recovered in an efficient manner.

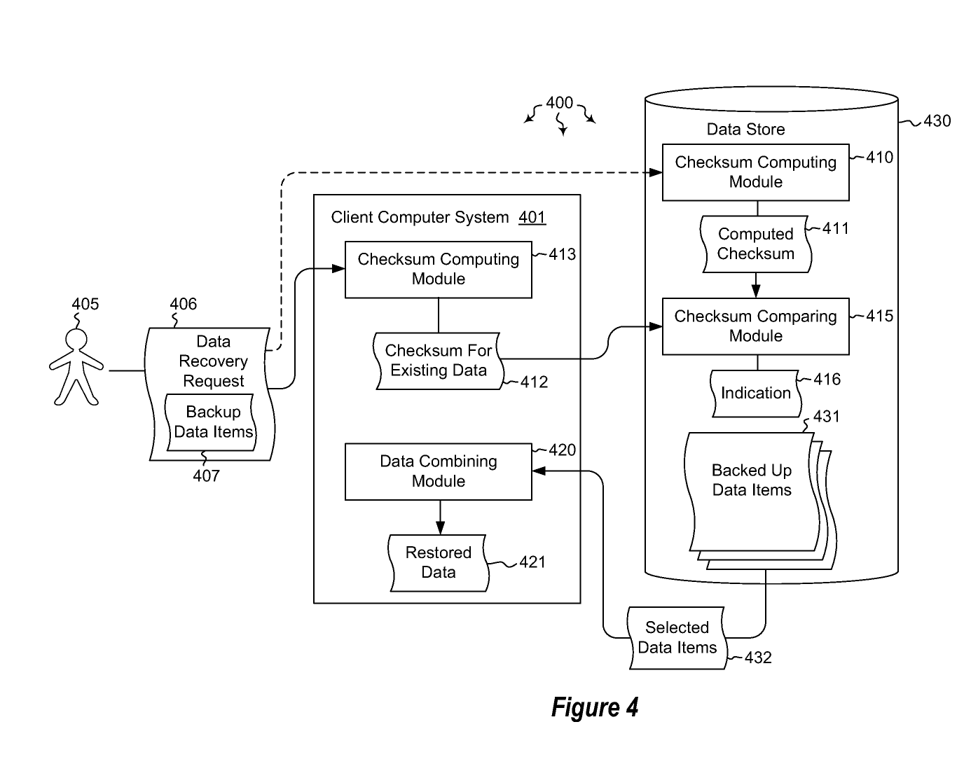

FIG. 3 illustrates a flowchart of a method 300 for efficiently transferring recovery data. The method 300 will now be described with frequent reference to the components and data of environment 400 of FIG. 4.

Method 300 includes an act of receiving from a user an indication of one or more backup data items which are to be recovered from a specified recovery point in a set of data backups (act 310). For example, client computer system 401 may receive data recovery request 406 from user 405. The data recovery request may specify various backup data items 407 that are to be recovered from a specified recovery point within the backed up data items 431. The backed up data items may be stored in data store 430, which is accessible by (or is directly attached to) the client computer system.

Method 300 also includes an act of computing checksum data corresponding to each of the user-specified backup data items (act 320). For example, checksum computing module 410 may compute a checksum 411 that corresponds to each user-specified backup data item 407. The computed checksums may be versioned, such that different checksums correspond to different versions of data items. The backup data may also be versioned, such that multiple different versions of a data item may be backed up. Each of these different backed up data items would have its own unique (versioned) checksum. When these versioned checksums are used, the backup data may be restored from a specified backup data version. In this manner, all files related to a given version may be restored together.

Method 300 includes an act of comparing the computed checksum data of the user-specified backup data files to checksum data associated with data items already on the user's computer system to determine which segments of the backup data items are to be restored to the user (act 330). For example, checksum comparing module 415 may compare the computed checksum 411 to one or more existing checksums 412. The existing checksums may correspond to data files that are already on the user's computer. The comparison may be used to determine which data items are already on the user's computer. Then, once it has been determined which data files are not already on the user's computer, those backed up data items for which a checksum did not already exist on the user's computer system (e.g. selected data items 432) may be restored from the backed up data items 431 (act 340). Thus, only data which does not have a data block with the same checksum is downloaded to the user's computer system.

Method 300 further includes an act of combining the received backup data items with the user's existing data items such that the user's data is fully recovered (act 350). Once the selected data items 432 have been received, data combining module 420 may combine the existing data with the received data to create the user's fully restored data 421. In some cases, the restored data items include data files for an entire data volume. During the data recovery, if the recovery is canceled or otherwise stopped due to a system failure, it may be resumed from the point of failure or cancellation. Moreover, the backup data may be restored to other locations than the original location on the user's computer system. For example, the backup data may be restored to other (perhaps remote) computer systems that are different than the computer system from which the data was originally backed up.

Accordingly, methods, systems and computer program products are provided which locate and restore backed up items using a custom-generated schema. Moreover, methods, systems and computer program products are provided which efficiently transfer recovery data by transferring only data that is not already on the user's computer system.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. At a computer system including at least one processor and a memory, in a computer networking environment including a plurality of computing systems, a computer-implemented method for locating and restoring backed up items using a custom schema, the method comprising:
an act of defining a schema configured to provide data search and retrieval among backup data sets, wherein the schema stores searchable attributes for each database item and leverages a file system to store file system metadata for the data items of the backup sets;
an act of receiving a request to find one or more data items among at least one of the backup data sets;
an act of accessing the schema to determine, from the stored searchable attributes, which recovery points among the backup data sets include the requested data items; and
an act of restoring the requested data items from the determined recovery point within the backup data sets.

2. The method of claim 1, wherein the searchable attributes comprise at least an indication of the time the data portion was first stored in the backup set and the time the data portion was last accessed.

3. The method of claim 2, wherein a user interface using the schema displays a span of backup sets the data portion is part of.

4. The method of claim 2, wherein the user interface shows, for each data item, the first recovery point and last recovery point.

5. The method of claim 1, wherein file system metadata includes parent information and file name information.

6. The method of claim 5, wherein the parent information is only stored once for all files stored under the parent.

7. The method of claim 5, wherein the parent information and file name information are stored in separate tables.

8. The method of claim 5, wherein the parent information includes a path that is split into two parts, the first of the two parts being limited in length to a predefined data length.

9. The method of claim 5, wherein one or more portions of extended information about child items are stored in an additional table, the additional table using a schema that is specific to the type of attributes stored and queried for, the extended information allowing for search and recovery functions that implement the extended information.

10. The method of claim 5, wherein child item information is extended to add one or more specific child item properties based on the context of the child item's data source.

11. The method of claim 1, wherein the restored items include data files for an entire data volume.

12. The method of claim 1, wherein the file system metadata is stored in a dataless virtual hard drive, the dataless virtual hard drive being configured to store data files created with their corresponding metadata and attributes, but without storing the actual data file's data.

13. The method of claim 12, wherein during data recovery, the dataless virtual hard drive is mounted and file system application programming interfaces are implemented to extract the metadata for the data items that are to be recovered.

14. A computer program product for implementing a method for efficiently transferring recovery data, the computer program product comprising one or more computer-readable storage media having stored thereon computer-executable instructions that, when executed by one or more processors of the computing system, cause the computing system to perform the method, the method comprising:
an act of receiving from a user an indication of one or more backup data items which are to be recovered from a specified recovery point in a set of data backups;
an act of computing checksum data corresponding to each of the user-specified backup data items;
an act of comparing the computed checksum data of the user-specified backup data files to checksum data associated with data items already on the user's computer system to determine which segments of the backup data items are to be restored to the user;
an act of receiving from at least one of the data backups those backed up data items for which a checksum did not already exist on the user's computer system; and
an act of combining the received backup data items with the user's existing data items such that the user's data is fully recovered.

15. The computer program product of claim 14, wherein the backup data and checksums are versioned.

16. The computer program product of claim 15, wherein backup data is restored from a specified backup data version.

17. The computer program product of claim 14, wherein only data which does not have a data block with the same checksum is downloaded to the user's computer system.

18. The computer program product of claim 14, wherein the backup data is restored to a location different than the original location from which the data was backed up.

19. The computer program product of claim 14, wherein the data recovery is resumable after a failure or cancellation.

20. A computer system comprising the following:
one or more processors;
system memory;
one or more computer-readable storage media having stored thereon computer-executable instructions that, when executed by the one or more processors, causes the computing system to perform a method for locating and restoring backed up items using a custom schema, the method comprising the following:
an act of defining a schema configured to provide data search and retrieval among backup data sets, wherein the schema stores searchable attributes for each database item and leverages a file system to store file system metadata for the data items of the backup sets, and wherein the file system metadata is stored in a dataless virtual hard drive, the dataless virtual hard drive being configured to store data files created with their corresponding metadata and attributes, but without storing the actual data file's data;
an act of receiving a request to find one or more data items among at least one of the backup data sets;
an act of accessing the schema to determine, from the stored searchable attributes, which recovery points among the backup data sets include the requested data items; and
an act of restoring the requested data items from the determined recovery point within the backup data sets, wherein during data recovery, the dataless virtual hard drive is mounted and file system application programming interfaces are implemented to extract the metadata for the data items that are to be recovered.
